(19) United States
(12) Patent Application Publication
(10) Pub. No.: US 2020/0048539 A1
(43) Pub. Date: Feb. 13, 2020

(54) SELF-BREAKING EMULSIFIED FLUID SYSTEM

(71) Applicant: HALLIBURT0N ENERGY SERVICES, INC., Houston, TX (US)

(72) Inventors: Monica Rajendra DANDAWATE, Pune (IN); Rajender SALLA, Pune (IN); Prashant D. CHOPADE, Kingwood, TX (US)

(73) Assignee: Halliburton Energy Services, Inc., Houston, TX (US)

(21) Appl. No.: 16/339,257

(22) PCT Filed: Nov. 3, 2016
(86) PCT No.: PCT/US2016/060225

§ 371 Date: Apr. 3, 2019

(51) Int. Cl. C09K 8/80; C07F 7/02

(52) U.S. Cl. CPC C09K 8/80; C07F 7/025

(57) ABSTRACT

Methods and compositions for treating a well with a self-breaking emulsified fluid system. One embodiment is a method comprising: providing a treatment fluid comprising: an emulsion comprising: an external phase comprising a hydrophobic and hydrolysable liquid; an internal aqueous phase, and an emulsifier; and a plurality of proppant particulates; and injecting the treatment fluid into a well bore penetrating at least a portion of a subterranean formation at or above a pressure sufficient to create or enhance one or more fractures in the subterranean formation.

### BACKGROUND

The present disclosure relates to methods and compositions for treating subterranean formations. A “subterranean formation” is a body of rock that has sufficiently distinctive characteristics and is sufficiently continuous for geologists to describe, map, and name it. A subterranean formation having a sufficient porosity and permeability to hold and transmit fluids is sometimes referred to as a “reservoir.” Oil and gas are naturally occurring hydrocarbons in certain subterranean formations such as reservoirs.

To produce oil or gas from a reservoir, a well bore is drilled into a subterranean formation, which may be the reservoir or adjacent to the reservoir. Subterranean treatments may be used to facilitate or enhance the production of desirable fluids such as oil or gas from or through a subterranean formation. Treatment fluids may be used in a variety of subterranean treatments to enhance the production of desirable fluids. As used herein, the term “treatment,” or “treating,” refers to any subterranean operation that uses a fluid in conjunction with a desired function and/or for a desired purpose. The term “treatment,” or “treating,” does not necessarily imply any particular action by the fluid.

Treatment fluids may comprise an emulsion. An emulsion is a fluid including a dispersion of immiscible liquid particles or droplets in an external (i.e., continuous) liquid phase. In addition, the proportion of the external and internal phases is above the solubility of either in the other. A stable emulsion is an emulsion that will not cream, flocculate, or coalesce under certain conditions, including time and temperature. As used herein, the term “cream” means at least some of the droplets of a dispersed phase converge towards the surface or bottom of the emulsion. The converged droplets maintain a discrete droplet form. As used herein, the term “flocculate” means at least some of the droplets of a dispersed phase combine to form small aggregates in the emulsion. As used herein, the term “coalesce” means at least some of the droplets of a dispersed phase combine to form larger drops in the emulsion.

A variety of different emulsions are possible. In the context of an emulsion, a “water phase” or “aqueous phase” refers to a phase of water or an aqueous solution. An “oil phase” refers to a phase of any non-polar, organic liquid that is immiscible with water, usually an oil. An oil-in-water emulsion refers to an internal oil phase surrounded by a continuous water phase. By contrast, a water-in-oil emulsion refers to an internal aqueous phase surrounded by a continuous oil phase. A water-in-oil emulsion is sometimes referred to as an invert emulsion.

An emulsion, including either the emulsions described above, may be used in a treatment fluid for a variety of purposes. In one example, the external phase may act as a carrier fluid for the internal phase. In this manner, the external phase may be used to isolate and or protect the internal phase from the environment of the well bore or the subterranean formation. In other example, an emulsion may be used to increase the viscosity of the treatment fluid for a desired application.

After an emulsion has been used in a particular treatment operation, it may be desirable to “break” the emulsion. As used herein, to “break,” in regard to an emulsion, means to cause the creaming and coalescence of emulsified drops of the internal dispersed phase so that the internal phase separates out of the external phase. For example, breaking an emulsion can be accomplished mechanically (for example, in settlers, cyclones, or centrifuges), or via dilution, or with chemical additives to increase the surface tension of the internal droplets.

### BRIEF DESCRIPTION OF THE DRAWINGS

These drawings illustrate certain aspects of some of the embodiments of the present disclosure, and should not be used to limit or define the claims.

FIG. 1 is a diagram illustrating an example of a fracturing system that may be used in accordance with certain embodiments of the present disclosure.

FIG. 2 is a diagram illustrating an example of a subterranean formation in which a fracturing operation may be performed in accordance with certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

The present disclosure relates to methods and compositions for treating subterranean formations. More particularly, the present disclosure relates to methods and compositions for treating a well with a self-breaking emulsified fluid system.

The present disclosure provides a treatment fluid comprising a self-breaking emulsified fluid system. In general, the treatment fluids of the present disclosure include an emulsion comprising an external phase comprising a hydrophobic and hydrolysable liquid and an internal aqueous phase. The treatment fluids of the present disclosure may be used in a variety of treatment operations including, for example, fracturing applications. For example, the treatment fluids of the present disclosure may be used to carry proppant for fracturing applications.

Among the many potential advantages to the methods and compositions of the present disclosure, only some of which are alluded to herein, the methods, compositions, and systems of the present disclosure may be used to provide an emulsified fluid system that is capable of breaking without the need for an internal breaker, an additional component that increases the cost and complexity of emulsified fluid systems. Also, certain previous approaches presented a risk of forming a more stable emulsion under down-hole conditions even after the emulsion in the treatment fluid is initially broken. In contrast, the compositions of the present disclosure substantially avoid the risk of forming an emulsion after breaking.

The methods and compositions of the present disclosure generally involve a treatment fluid for use in subterranean treatment operations. The treatment fluid comprises an emulsion. In some embodiments, the emulsion can be characterized as an oil-free emulsion or an emulsion that is substantially free of oil. In particular, the emulsion comprises an external phase comprising a hydrophobic and hydrolysable liquid, an internal aqueous phase, and an emulsifier. In some embodiments, the treatment fluid may further comprise a plurality of proppant particulates. Certain embodiments of the methods and compositions of the present disclosure are discussed herein.

According to an embodiment of the present disclosure, the treatment fluid of the present disclosure comprises an emulsion. An emulsion is a fluid including a dispersion of immiscible liquid particles or droplets in an external liquid phase. A chemical can be included to reduce the interfacial tension between the two immiscible liquids to help reduce or prevent coalescing of the internal liquid phase, in which case the chemical may be referred to as a surfactant or more particularly as an emulsifier or emulsifying agent.

The external phase of the emulsion comprises a hydrophobic and hydrolysable liquid. As used herein, the term hydrophobic means the liquid is immiscible in water. As used herein, the term hydrolysable means that the liquid is generally capable of hydrolysis when exposed to water. While a hydrolysable liquid is capable of hydrolysis, however, the liquid may hydrolyze only after a certain time or it may hydrolyze over a particular duration. The hydrolysis time may depend on the temperature. By way of explanation and not by limitation, the hydrophobic and hydrolysable liquid may act as an oil substitute in the emulsion. In certain embodiments, the external phase of the emulsion is substantially free of any oil known in the art, including but not limited to diesel oil, mineral oil, synthetic oil, enhanced mineral oil, and any combination thereof. In some embodiments, the external phase of the emulsion of the treatment fluid does not contain anything that would adversely interact with the other components used in the fluid or with the subterranean formation.

In general, a variety of hydrophobic and hydrolysable liquids may be suitable for the emulsion of the treatment fluids of the present disclosure. In some embodiments, the hydrophobic and hydrolysable liquid may comprise a silane derivative. As used herein, a silane derivative refers to a derivative of SiH₄ where one or more of the hydrogens have been substituted with another functional group provided that the resulting derivative is both hydrophobic and hydrolysable. In some embodiments, the hydrophobic and hydrolysable liquid may comprise tetrapropoxy orthosilicate, tetrabutoxy orthosilicate, tertapentyl orthosilicate etc as well as 3-Glycidyloxypropropyl)trimethoxy silane (GPTMS) ethyl-linked bis(triethoxysilyl)-ethane (BTESE), hexyl-linked bis(trimethoxysilyl)-hexane (BTMSH), and any combination thereof. In some embodiments, the hydrophobic and hydrolysable liquid may comprise an alkyl ether of orthosilicic acid. In certain embodiments, the hydrophobic and hydrolysable liquid may comprise tetraethyl orthosilicate.

In some embodiments, the external phase of the emulsion may further comprise any oil known in the art, including but not limited to diesel oil, mineral oil, synthetic oil, enhanced mineral oil, and any combination thereof. In these embodiments, a mixture of hydrophobic and hydrolysable liquid and oil may be used to control the breaking time of the emulsion. For example, a ratio of hydrophobic and hydrolysable liquid to oil may be determined based on a desired breaking time. In some embodiments, using a higher concentration of hydrophobic and hydrolysable liquid results in a shorter breaking time.

The internal aqueous phase of the emulsion comprises water. In some embodiments, the aqueous phase may include freshwater or other water sources. Other sources of water can include surface water ranging from brackish water to seawater, brine, returned water (sometimes referred to as flowback water) from the delivery of a fluid into a well, unused fluid, and produced water. In some embodiments, the water for use in the emulsion of the treatment fluid does not contain anything that would adversely interact with the other components used in the fluid or with the subterranean formation. For example, in general, for water to be suitable for use in common well treatments, it should not contain one or more materials that would be particularly detrimental to the chemistry involved in such well treatments. In addition, in some embodiments, the water is cleaned of undissolved, suspended solids (for example, silt) at least to a point that the natural permeability and the conductivity of the fracture will not be damaged. For this purpose, all the water used in a well treatment can be filtered to help reduce the concentration of suspended, undissolved solids that may be present in the water, such as silt.

According to an embodiment of the present disclosure, the internal aqueous phase of the emulsion has a pH from about 6 to about 8. In certain embodiments, a buffering agent may be used to maintain the desired pH. In certain embodiments, a buffering agent may be used when the treatment fluid is introduced into a subterranean formation having an acidic environment.

In some embodiments, the aqueous phase of the treatment fluid may optionally comprise one or more dissolved salts or can be a brine. Suitable salts may include, but are not limited to, calcium chloride, sodium chloride, magnesium chloride, potassium chloride, sodium bromide, potassium bromide, ammonium chloride, sodium formate, potassium formate, cesium formate, mixtures thereof, and the like. The concentration of a salt added may be the amount necessary for formation compatibility, such as stability of clay minerals, taking into consideration the crystallization temperature of the brine, for example, the temperature at which the salt precipitates from the brine as the temperature drops. For example, the brine can be chosen to be compatible with the formation to be treated and to provide the appropriate degree of well control.

The emulsion of the treatment fluid of the present disclosure further comprises an emulsifier. As used herein, an “emulsifier” refers to a type of surfactant that helps prevent the droplets of the dispersed phase of an emulsion from flocculating or coalescing in the emulsion. Examples of emulsifiers that may be suitable include, but are not limited to, emulsifiers with an HLB (Davies' scale) in the range of about 4 to about 35. An emulsifier or emulsifier package is preferably in a concentration of at least 1% by weight of the emulsion. More preferably, the emulsifier is in a concentration in the range of 1% to 10% by weight of the emulsion.

Without limiting the disclosure to any particular theory or mechanism, the combination of an external phase comprising a hydrophobic and hydrolysable liquid and an internal aqueous phase provides for a self-breaking emulsion. In particular, the external phase may slowly hydrolyze at its interface with the internal aqueous phase. The hydrolysis results in the gradual degradation of the external phase and eventual self-breaking of the emulsion. Moreover, once the emulsion has broken, in many embodiments, it cannot re-form because the external phase has degraded.

A person of skill in the art, with the benefit of this disclosure, may be able to control the rate at which the emulsion breaks. Factors that determine the rate at which the emulsion breaks include, for example, the type of hydrophobic and hydrolysable liquid used, the ratio of hydrophobic and hydrolysable liquid to water, and the degree to which the treatment fluid is emulsified.

In some embodiments, a particular hydrophobic and hydrolysable liquid may be chosen based on one or more known conditions of the well such as temperature. For example, a hydrophobic and hydrolysable liquid may be chosen to control the duration of time necessary to hydrolyze at the temperature in the well. In certain embodiments, a controlled break of the emulsion can be achieved by selecting a longer chain alkyl ether of orthosilicates that may take longer to hydrolyze. In certain embodiments, a longer hydrolysis time results in a more stable emulsion for a given temperature. In this way, the emulsion of a treatment fluid can be designed to break after a particular time.

In some embodiments, the treatment fluids of the present disclosure may further comprise a plurality of proppant particulates. A proppant particulate is in the form of a solid particulate, which can be suspended in the treatment fluid, carried downhole, and deposited in the fracture to form a proppant pack. The proppant pack props the fracture in an open condition while allowing fluid flow through the permeability of the pack. The proppant pack in the fracture provides a higher-permeability flow path for the oil or gas to reach the well bore compared to the permeability of the matrix of the surrounding subterranean formation. This higher-permeability flow path increases oil and gas production from the subterranean formation.

A particulate for use as a proppant particulate is usually selected based on the characteristics of size range, crush strength, and solid stability in the types of fluids that are encountered or used in wells. Examples of suitable proppant particulate materials include, without limitation, sand, gravel, bauxite, ceramic materials, glass materials, polymer materials, wood, plant and vegetable matter, nut hulls, walnut hulls, cottonseed hulls, cured cement, fly ash, fibrous materials, composite particulates, hollow spheres or porous particulate. Mixtures of different kinds or sizes of proppant particulate can be used as well. Further, a suitable proppant particulate should be stable over time and not dissolve in fluids commonly encountered in a well environment. Preferably, a proppant particulate material is selected that will not dissolve in water or the hydrophobic and hydrolysable fluid.

The proppant particulate is usually selected to be an appropriate size to prop open the fracture and bridge the fracture width expected to be created by the fracturing conditions and the fracturing fluid. If the proppant particulate is too large, it may not easily pass into a fracture and may screen-out too early. If the proppant particulate is too small, it may not provide the fluid conductivity to enhance production. In the case of fracturing relatively permeable or even tight-gas reservoirs, a proppant pack should provide higher permeability than the matrix of the formation. In the case of fracturing ultra-low permeable formations, such as shale formations, a proppant pack should provide for higher permeability than the naturally occurring fractures or other micro-fractures of the fracture complexity. Appropriate sizes of particulate for use as a proppant particulate are typically in the range from about 8 to about 100 U.S. Standard Mesh. In certain embodiments, a proppant particulate may be sand-sized, which geologically is defined as having a largest dimension ranging from about 0.06 millimeters up to about 2 millimeters (mm).

According to embodiments of the present disclosure, the concentration of proppant particulate in the treatment fluid may depends upon factors such as the nature of the subterranean formation. As the nature of subterranean formations may differ, the concentration of proppant particulate in the treatment fluid may be in the range of from about 0.1 pounds to about 25 pounds of proppant particulate per gallon of liquid phase of the treatment fluid. In some embodiments, the concentration of proppant particulate in the treatment fluid may be in the range of from about 0.1 lb/gal to about 10 lb/gal.

In certain embodiments, the treatment fluids used in the methods and compositions of the present disclosure optionally may comprise any number of additional additives. Examples of such additional additives include, but are not limited to, salts, surfactants, diverting agents, fluid loss control additives, gas, nitrogen, carbon dioxide, surface modifying agents, tackifying agents, consolidating agents, foamers, corrosion inhibitors, scale inhibitors, catalysts, clay control agents, biocides, friction reducers, antifoam agents, bridging agents, flocculants, H₂S scavengers, CO₂ scavengers, oxygen scavengers, hydrate inhibitors, lubricants, additional viscosifiers, weighting agents, relative permeability modifiers, resins, wetting agents, coating enhancement agents, filter cake removal agents, antifreeze agents (e.g., ethylene glycol), and the like. A person skilled in the art, with the benefit of this disclosure, will recognize the types of additives that may be included in the fluids of the present disclosure for a particular application.

A treatment fluid according to the present disclosure may be prepared at the job site, prepared at a plant or facility prior to use, or certain components of the fluid can be pre-mixed prior to use and then transported to the job site. In certain embodiments, the preparation of a fluid can be done at the job site in a method characterized as being performed “on the fly.” The term “on-the-fly” is used herein to include methods of combining two or more components wherein a flowing stream of one element is continuously introduced into flowing stream of another component so that the streams are combined and mixed while continuing to flow as a single stream as part of the on-going treatment. Such mixing can also be described as “real-time” mixing. In offshore operations where storage capacity is limited emulsions are preferably mixed on the fly.

It has been discovered that the use of the hydrophobic and hydrolysable fluids of the present disclosure may obviate the need for surface modifying agents used with proppant particulate. When using proppant particulates in a conventional water-in-oil emulsion, it can be necessary to first coat the proppant particulate with a surface modifying agent. However, surface modifying agents (and particularly tackifying agents) can create operational difficulties such as the difficulty to deliver the agent to the well site and the difficulty to clean the agent from field equipment. Surface modifying agents can be expensive as well. It has been discovered that simply coating the proppant particulates with the hydrophobic and hydrolysable fluids of the present disclosure (such as tetraethyl orthosilicate) followed by the addition of the water and emulsifier can create a suitable emulsion without the use of a surface modifying agent. This can save time and expense compared to conventional methods. However, in other embodiments, surface modifying agents may be used in conjunction with the methods and compositions of the present disclosure.

According to an embodiment of the present disclosure, a method of treating a subterranean formation is provided, the method including the steps of: forming a treatment fluid according to the present disclosure; and introducing the treatment fluid into a well bore or a subterranean formation. In some embodiments, the treatment fluid may be introduced into a well bore that penetrates a subterranean formation. In some embodiments, the treatment fluid may be introduced at a pressure sufficient to create or enhance one or more fractures within the subterranean formation. In some embodiments, the treatment fluid may flow back to the surface.

After the step of introducing a treatment fluid into a well bore or a subterranean formation, the method can include allowing time for the emulsion to break in the formation, separating the two phases substantially such that the emulsion is broken. In certain embodiments, a displacement fluid may be introduced into the well bore after injecting the treatment fluid.

In certain embodiments, the step of introducing the treatment fluid into the well bore or the subterranean formation may further comprise a step of designing or determining a fracturing treatment for a treatment zone of the subterranean formation. For example, a step of designing can comprise: (a) determining the design temperature and design pressure; (b) determining the total designed pumping volume of the one or more treatment fluids to be pumped into the subterranean formation at a rate and pressure above the fracture pressure of the subterranean formation; (c) designing a treatment fluid, including its composition and rheological characteristics; (d) designing the pH of the treatment fluid; (e) determining the size of a proppant particulate of a proppant pack previously formed or to be formed in fractures in the subterranean formation; or (f) designing the loading of any proppant particulate in the treatment fluid. In one embodiment, for example, a person of skill in the art with the teachings of this disclosure may determine a concentration of alkaline buffering agent based on the designed pH of the treatment fluid.

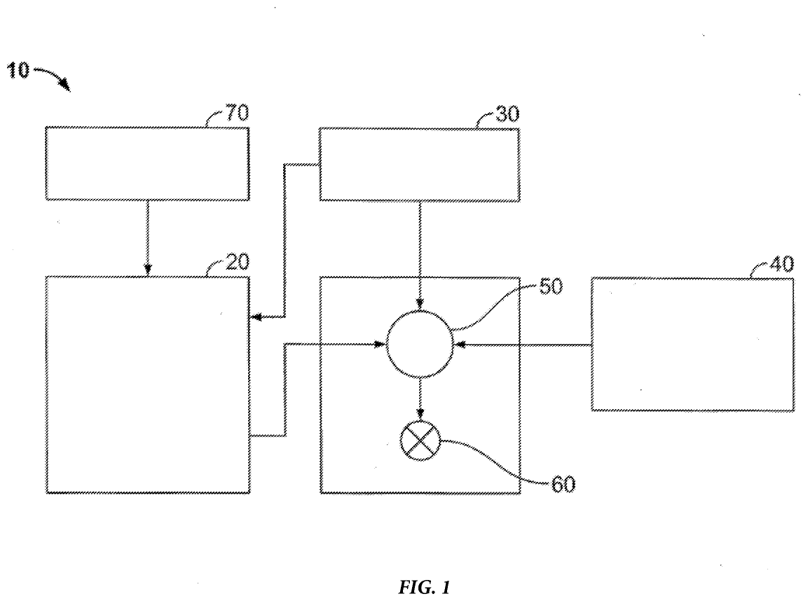

The exemplary methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary fracturing system 10, according to one or more embodiments. In certain instances, the system 10 includes a fracturing fluid producing apparatus 20, an emulsion source 30, a proppant source 40, and a pump and blender system 50 and resides at the surface at a well site where a well 60 is located. In certain instances, the fracturing fluid producing apparatus 20 combines additives with an emulsion from emulsion source 30, to produce a fracturing fluid that is used to fracture the formation. The fracturing fluid can be a fluid for ready use in a fracture stimulation treatment of the well 60. In other instances, the fracturing fluid producing apparatus 20 can be omitted and the fracturing fluid sourced directly from the emulsion source 30.

The proppant source 40 can include a proppant for combination with the fracturing fluid. The system may also include additive source 70 that provides one or more optional additives to alter the properties of the fracturing fluid. For example, the other additives 70 can be included to reduce pumping friction, to reduce or eliminate the fluid's reaction to the geological formation in which the well is formed, to operate as surfactants, and/or to serve other functions.

The pump and blender system 50 receives the fracturing fluid and combines it with other components, including proppant from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, emulsion source 30, and/or proppant source 40 may be equipped with one or more metering devices (not shown) to control the flow of fluids, proppants, and/or other compositions to the pumping and blender system 50. Such metering devices may permit the pumping and blender system 50 can source from one, some or all of the different sources at a given time, and may facilitate the preparation of fracturing fluids in accordance with the present disclosure using continuous mixing or “on-the-fly” methods. Thus, for example, the pumping and blender system 50 can provide just fracturing fluid into the well at some times, just proppants at other times, and combinations of those components at yet other times.

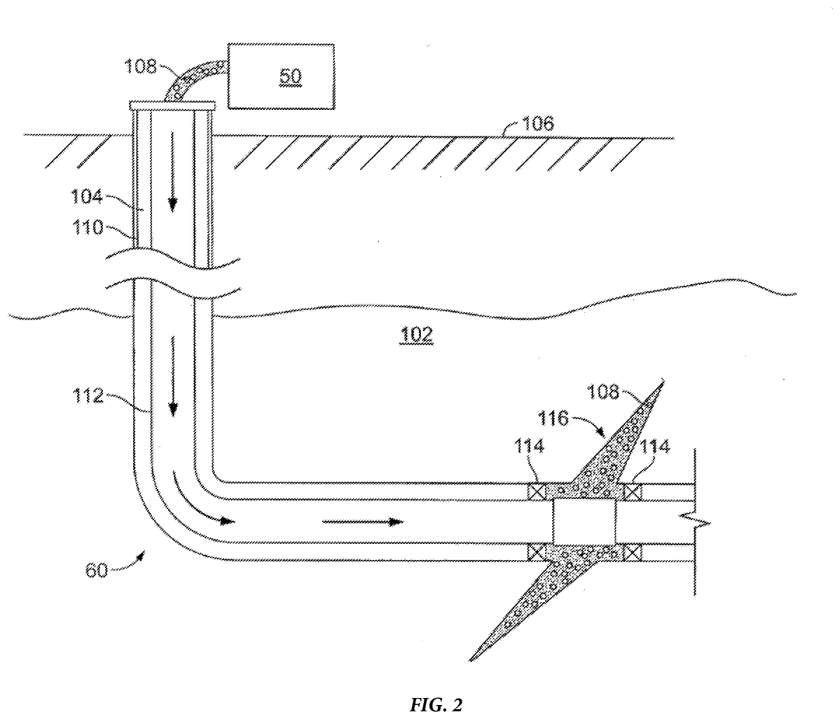

FIG. 2 shows the well 60 during a fracturing operation in a portion of a subterranean formation of interest 102 surrounding a well bore 104. The well bore 104 extends from the surface 106, and the fracturing fluid 108 is applied to a portion of the subterranean formation 102 surrounding the horizontal portion of the well bore. Although shown as vertical deviating to horizontal, the well bore 104 may include horizontal, vertical, slant, curved, and other types of well bore geometries and orientations, and the fracturing treatment may be applied to a subterranean zone surrounding any portion of the well bore. The well bore 104 can include a casing 110 that is cemented or otherwise secured to the well bore wall. The well bore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro-jetting and/or other tools.

The well is shown with a work string 112 depending from the surface 106 into the well bore 104. The pump and blender system 50 is coupled a work string 112 to pump the fracturing fluid 108 into the well bore 104. The working string 112 may include coiled tubing, jointed pipe, and/or other structures that allow fluid to flow into the well bore 104. The working string 112 can include flow control devices, bypass valves, ports, and or other tools or well devices that control a flow of fluid from the interior of the working string 112 into the subterranean zone 102. For example, the working string 112 may include ports adjacent the well bore wall to communicate the fracturing fluid 108 directly into the subterranean formation 102, and/or the working string 112 may include ports that are spaced apart from the well bore wall to communicate the fracturing fluid 108 into an annulus in the well bore between the working string 112 and the well bore wall.

The working string 112 and/or the well bore 104 may include one or more sets of packers 114 that seal the annulus between the working string 112 and well bore 104 to define an interval of the well bore 104 into which the fracturing fluid 108 will be pumped. FIG. 2 shows two packers 114, one defining an uphole boundary of the interval and one defining the downhole end of the interval. When the fracturing fluid 108 is introduced into well bore 104 (e.g., in FIG. 2, the area of the well bore 104 between packers 114) at a sufficient hydraulic pressure, one or more fractures 116 may be created in the subterranean zone 102. The proppant particulates in the fracturing fluid 108 may enter the fractures 116 where they may remain after the fracturing fluid flows out of the well bore. These proppant particulates may “prop” fractures 116 such that fluids may flow more freely through the fractures 116.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

### EXAMPLE

To facilitate a better understanding of the present disclosure, the following examples of certain aspects of preferred embodiments are given. The following examples are not the only examples that could be given according to the present disclosure and are not intended to limit the scope of the disclosure or claims.

A series of tests were performed to evaluate the effect of using a hydrophobic and hydrolysable fluid instead of oil in a water-internal type emulsion. First, a standard water-in-oil emulsion was prepared as Formulation 1. A sample of 36 grams (6 lb/gal) of sand was coated with SandWedge® NT surface modifying agent (available from Halliburton Energy Services). The coated sand was added to 47.12 mL water, 2.38 mL oil, and 0.5 mL EZ MUL® NT emulsifier (available from Halliburton Energy Services). The emulsion was placed under an overhead stirrer and stirred at about 700-1000 RMP until an emulsion was formed.

Second, an emulsion was prepared according to an embodiment of the present disclosure as Formulation 2. This was prepared using the same protocol as Formulation 1 except that (1) tetraethyl orthosilicate (TEOS) was used instead of oil and (2) the SandWedge® NT surface modifying agent was omitted.

The stabilities of both formulations was tested in a water bath at 200° F. The results are shown in Table 1 below:

TABLE 1

| Formulation | External Phase | Emulsion Formation Time | Break Time |
|---|---|---|---|
| 1 | Oil | 35 Seconds | Did Not |
| | | | Break |
| 2 | TEOS | 35 Seconds | 1.5 Hours |

As shown above, using an oil-equivalent hydrolysable silane (such as TEOS) may be used to provide a water-internal type emulsion for downhole applications. These emulsions are stable at 200° F. for at least one hour yet are able to break without the use of an additional de-emulsifier.

An embodiment of the present disclosure is a method comprising: providing a treatment fluid comprising: an emulsion comprising: an external phase comprising a hydrophobic and hydrolysable liquid; an internal aqueous phase, and an emulsifier; and a plurality of proppant particulates; and injecting the treatment fluid into a well bore penetrating at least a portion of a subterranean formation at or above a pressure sufficient to create or enhance one or more fractures in the subterranean formation. Optionally, the hydrophobic and hydrolysable liquid comprises a silane derivative. Optionally, the silane derivative comprises tetraethyl orthosilicate. Optionally, the emulsion is substantially free of oil. Optionally, the method further comprises: allowing the emulsion to break after the treatment fluid is injected into the wellbore. Optionally, the method further comprises: injecting a displacement fluid into the well bore after the emulsion is allowed to break. Optionally, the treatment fluid is injected into the well bore using one or more pumps.

Another embodiment of the present disclosure is a method comprising: providing a treatment fluid comprising an emulsion comprising: an external phase comprising a hydrophobic and hydrolysable liquid, an internal aqueous phase, and an emulsifier; and injecting the treatment fluid into a well bore penetrating at least a portion of a subterranean formation. Optionally, the hydrophobic and hydrolysable liquid comprises a silane derivative. Optionally, the silane derivative comprises tetraethyl orthosilicate. Optionally, the emulsion is substantially free of oil. Optionally, the method further comprises: allowing the emulsion to break after the treatment fluid is injected into the wellbore. Optionally, the method further comprises: injecting a displacement fluid into the well bore after the emulsion is allowed to break. Optionally, the treatment fluid is injected into the well bore using one or more pumps.

Another embodiment of the present disclosure is a composition comprising: an emulsion that comprises: an external phase comprising a hydrophobic and hydrolysable liquid, an internal aqueous phase, and an emulsifier. Optionally, the composition further comprises a plurality of proppant particulates. Optionally, the hydrophobic and hydrolysable liquid comprises a silane derivative. Optionally, the silane derivative comprises tetraethyl orthosilicate. Optionally, the emulsion is substantially free of oil. Optionally, the emulsifier has an HLB of from about 4 to about 35.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
providing a treatment fluid comprising:
an emulsion comprising: an external phase comprising a hydrophobic and hydrolysable liquid; an internal aqueous phase, and an emulsifier; and
a plurality of proppant particulates; and
injecting the treatment fluid into a well bore penetrating at least a portion of a subterranean formation at or above a pressure sufficient to create or enhance one or more fractures in the subterranean formation.

2. The method of claim 1 wherein the hydrophobic and hydrolysable liquid comprises a silane derivative.

3. The method of claim 2 wherein the silane derivative comprises tetraethyl orthosilicate.

4. The method of claim 1 wherein the emulsion is substantially free of oil.

5. The method of claim 1 further comprising: allowing the emulsion to break after the treatment fluid is injected into the wellbore.

6. The method of claim 5 further comprising: injecting a displacement fluid into the well bore after the emulsion is allowed to break.

7. The method of claim 1 wherein the treatment fluid is injected into the well bore using one or more pumps.

8. A method comprising:
providing a treatment fluid comprising an emulsion comprising:
an external phase comprising a hydrophobic and hydrolysable liquid,
an internal aqueous phase, and
an emulsifier; and
injecting the treatment fluid into a well bore penetrating at least a portion of a subterranean formation.

9. The method of claim 8 wherein the hydrophobic and hydrolysable liquid comprises a silane derivative.

10. The method of claim 9 wherein the silane derivative comprises tetraethyl orthosilicate.

11. The method of claim 8 wherein the emulsion is substantially free of oil.

12. The method of claim 8 further comprising: allowing the emulsion to break after the treatment fluid is injected into the wellbore.

13. The method of claim 12 further comprising: injecting a displacement fluid into the well bore after the emulsion is allowed to break.

14. The method of claim 8 wherein the treatment fluid is injected into the well bore using one or more pumps.

15. A composition comprising an emulsion that comprises:
an external phase comprising a hydrophobic and hydrolysable liquid,
an internal aqueous phase, and
an emulsifier.

16. The composition of claim 15 further comprising a plurality of proppant particulates.

17. The composition of claim 15 wherein the hydrophobic and hydrolysable liquid comprises a silane derivative.

18. The composition of claim 15 wherein the silane derivative comprises tetraethyl orthosilicate.

19. The composition of claim 15 wherein the emulsion is substantially free of oil.

20. The composition of claim 15 wherein the emulsifier has an HLB of from about 4 to about 35.
